(19) United States
(12) Patent Application Publication
(10) Pub. No.: US 2018/0050280 A1
(43) Pub. Date: Feb. 22, 2018

(54) CRYSTALLIZER AND METHOD FOR WATER RECLAMATION

(71) Applicant: Naveed Aslam, Houston, TX (US)

(72) Inventor: Naveed Aslam, Houston, TX (US)

(21) Appl. No.: 15/238,320

(22) Filed: Aug. 16, 2016

(51) Int. Cl. B01D 9/00; C02F 1/22; C02F 1/68; C02F 1/52

(52) U.S. Cl. CPC B01D 9/0009; B01D 9/0063; C02F 1/22; C02F 2103/10; C02F 1/5236; B01D 2009/0086; C02F 1/68

(57) ABSTRACT

A method and crystallizer for treating produced water through the steps of feeding produced water to a porous pipe in a chamber wherein the chamber is cylindrically shaped having an interior wall with a top and a bottom; feeding gaseous nitrogen to a nozzle present in the chamber, which is in fluid communication with an interior pipe; feeding the produced water to the interior pipe wherein slush is formed in the pipe and this slush is forced through the interior pipe to the top of the chamber; operating at least one scraper which is mounted circumferentially about the porous pipe and having arms that extend outwardly from the scraper center in contact with the interior wall of the chamber wherein the scraper will remove salt crystals from the interior walls of the chamber; recovering salt crystals from the bottom of the chamber; and recovering fresh water from the chamber.

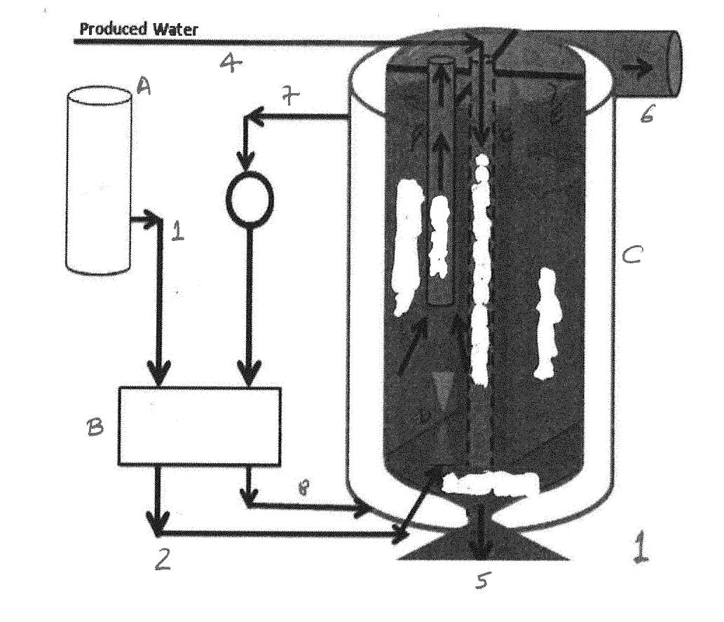

### BACKGROUND OF THE INVENTION

Hydraulic fracturing is becoming a desirable method for extracting hydrocarbons. However, this method is being given scrutiny by public and regulatory agencies due to their extensive requirement for and consumption of water.

This problem is exacerbated in certain regions of the United States because there is a water shortage to contend with. The Permian Basin in Texas is one such area so there is a continuous need for methods that use water more efficiently in the hydraulic fracturing operations.

Typically the produced water that is recovered is characterized by unusually high percentages of dissolved solids (TDS) in the range of 50,000 to 600,000 parts per million which makes these types of water not suitable for reverse osmosis units. Evaporative crystallization (EC) technologies are also not desirable due to their low efficiencies due to the heat of evaporation of water

The present invention provides for a crystallizer for treatment of produced water from oil and gas production processes, and a method of using the crystallizer for treating produced water from oil and gas production processes.

### SUMMARY OF THE INVENTION

In a first embodiment of the invention, there is disclosed a crystallizer comprising a chamber being cylindrical in shape and comprising an interior wall and a top and a bottom, the chamber being in fluid communication with a pipe for introducing produced water from an oil and gas production process, the pipe is in fluid communication with a porous pipe to allow for distribution of the produced water into the chamber; a source of nitrogen in fluid communication with a nozzle wherein the nozzle is located inside the chamber and is in fluid communication with an interior pipe which is further in fluid communication with the produced water; at least one scraper which is mounted circumferentially about the porous pipe and having arms that extend outwardly from the scraper center in contact with the interior wall of the chamber thereby scraping salt crystals on the interior wall of the chamber; and a top pipe in fluid communication with the chamber thereby to remove fresh water from the chamber.

In a second embodiment of the invention, there is disclosed a method for treating produced water from a gas and oil production process comprising the steps of:

a) Feeding produced water to a porous pipe in a chamber wherein the chamber is cylindrically shaped having an interior wall with a top and a bottom;

b) Feeding gaseous nitrogen to a nozzle present in the chamber, wherein the nozzle is in fluid communication with an interior pipe;

c) Feeding the produced water to the interior pipe wherein slush is formed in the pipe and this slush is forced through the pipe to the top of the chamber;

d) Operating at least one scraper which is mounted circumferentially about the porous pipe and having arms that extend outwardly from the scraper center in contact with the interior wall of the chamber wherein the scraper will contact and remove salt crystals from the interior walls of the chamber;

e) Recovering salt crystals from the bottom of the chamber; and

f) Recovering fresh water from the chamber,

The gaseous nitrogen is typically formed by feeding liquid nitrogen to a fluid temperature control system which can cool process fluids while reducing the risk of freezing.

The gaseous nitrogen is also recovered from the chamber after it has flowed to the top of the chamber and this recovered nitrogen can be fed to the fluid temperature control system to provide some heat exchange before being fed into the chamber.

The produced water is fed to a porous pipe which can be any pipe constructed in a manner to allow for the distribution of the produced water throughout the chamber.

The nozzle will feed both the gaseous nitrogen and the produced water to the pipe present in the chamber. The interaction of the gas and produced water will produce slush or ice crystals which will flow upwards through the pipe to the top of the chamber where the slush or ice crystals will be recovered as fresh water and removed from the chamber.

Depending upon the throughput of the crystallizer, the flow rates for the gases will vary. The liquid nitrogen flow is directly dependent upon the cooling duty for the crystallizer whether it is a 5 gallon per minute size or larger.

The produced water achieves supersaturation as it enters the crystallizer and the ice solubility limits of −4° to −10° C. are reached. Ice crystals will then start forming and the solution will advance temperature wise to the eutectic point. At the eutectic point, salt will start coming out of the produced water.

The scraper is a device that is mounted circumferentially about the porous pipe. The scraper has arms that extend outwards from its center and contact the interior walls of the chamber. The scraper will be operated periodically and rotated between 0° and 180° so that the arms will contact any salts that have formed on the interior walls of the chamber. These salts will then drop to the bottom of the chamber where they can be recovered in solution from the bottom of the chamber and used accordingly.

The scraper is typically drive by an electric motor or through exhaust gaseous nitrogen. The scraper will contact and clean the internal surface of the crystallizer to remove salt deposition that can occur. This keeps the surface of the crystallizer clean thereby improving thermal efficiency of the operation as well as improving the yield of salt.

The various components of the crystallizer unit could be made from plastics or polymeric materials or ordinary steel coated with fluoro polymers. Since this is a low temperature design for water reclamation there is little likelihood of scaling and fouling effects and therefore the unit does not require more expensive material further lowering the overall CAPEX for the unit.

The nozzle is typically designed to avoid clogging while rapidly cooling and assisting in the crystallization of ice crystals from the water feed through the expansion of liquid nitrogen.

Previous attempts at commercialization of indirect crystallizers to treat high total dissolved solids water were less successful due to the high CAPEX and OPEX involved in the separation of ice and salt crystals as well as the cooling loop and refrigerant compressor design.

The present invention avoids these difficulties because the separation of ice and salt is performed in the same unit using the same fluid thereby lowering CAPEX and OPEX by intensifying energy but also mass exchange in one unit.

Further the crystallizer of the present invention has a lower energy requirement compared to distillation or evaporative crystallizers as the latent heat of fusion of ice is only one seventh that of the latent heat of vaporization.

The lower operating temperatures further result in minimizing scaling and corrosion effects from the water present in the crystallizer chamber. This allows the operator to use lower cost materials of construction.

The high surface area by the direct contact between the produced water and liquid nitrogen results in a greater heat transfer coefficient.

The design per the present invention allows for no pretreatment of the produced water before being treated in the crystallizer.

The present invention further provides for the recovery of salts in near pure form allowing for their reuse or sale for use in other applications.

The present invention provides for a modular and movable crystallizer allowing for the unit to be moved to where there is a need to treat produced water.

The present invention further provides a high turn down ratio or TDR. This reflects the maximum capacity to minimum capacity in terms of flow so a unit with good TDR is desirable as when the feed flow changes the unit can adjust and still perform the desired work without upset the operability of the unit.

### BRIEF DESCRIPTION OF THE DRAWINGS

The figure is a schematic of a crystallizer for use in the methods of the present invention.

### DETAILED DESCRIPTION OF THE INVENTION

A crystallizer 1 is shown in the Figure as well as a schematic of the operation of the crystallizer in the method of the invention. Produced water from an oil and gas production process is fed through line 4 to a porous pipe G which will distribute the produced water throughout the chamber C.

Liquid nitrogen is fed from a liquid nitrogen source A through line 1 to a fluid temperature control system B which will cool the liquid nitrogen and form gaseous nitrogen. Such a system may be a CUMULUS system available from Linde AG. The gaseous nitrogen is fed from the fluid temperature control system B through line 2 to the chamber C where it will enter a nozzle D.

The nozzle D will also be in fluid communication with the produced water present in chamber C and will direct the produced water and gaseous nitrogen to an interior pipe F where they will form slush or ice crystals in the interior pipe F. This slush or ice crystals will be forced through the top of the interior pipe F where they can be recovered as fresh water from the chamber through line 6.

The gaseous nitrogen will be recovered from the top of the chamber C where it will be fed through line 7 to the fluid temperature control system B where it can then be cooled in temperature and fed through line 8 back to the chamber C and nozzle D.

A scraper E is mounted circumferentially around the porous pipe G. The scraper E will have arms extending outwards from its center and these arms will contact at least a portion of the height of the interior wall of the chamber C. This scraper will be driven by an electric motor or exhaust gaseous nitrogen. This scraper E will be operated periodically and the arms will contact salts that have formed on the interior walls of the chamber C. These salts are the byproducts of contaminants present in the produced water and will be separated out as a result of the operation of the crystallizer 1. The salts will be removed from the bottom of the chamber C through line 5 where they can be recovered, purified further as necessary and reused in suitable industrial operations or disposed of in an environmentally responsible manner.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A crystallizer comprising a chamber being cylindrical in shape and comprising an interior wall and a top and a bottom, the chamber being in fluid communication with a pipe for introducing produced water, the pipe is in fluid communication with a porous pipe to allow for distribution of the produced water through the interior of the chamber; a source of gaseous nitrogen in fluid communication with a nozzle wherein the nozzle is located inside the chamber and is in fluid communication with an interior pipe which is further in fluid communication with the produced water; at least one scraper which is mounted circumferentially about the porous pipe and having arms that extend outwardly from the scraper center in contact with the interior wall of the chamber thereby scraping salt crystals on the interior wall of the chamber; and a top pipe in fluid communication with the chamber thereby to remove fresh water from the chamber.

2. The crystallizer as claimed in claim 1 wherein the produced water is from an oil and gas production process.

3. The crystallizer as claimed in claim 1 wherein the gaseous nitrogen is formed by feeding liquid nitrogen to a fluid temperature control system.

4. The crystallizer as claimed in claim 1 wherein gaseous nitrogen is recovered from the chamber and fed to the fluid temperature control system.

5. The crystallizer as claimed in claim 1 wherein the porous pipe distributes the produced water throughout the chamber.

6. The crystallizer as claimed in claim 1 wherein the nozzle feeds produced water and gaseous nitrogen to the interior pipe.

7. The crystallizer as claimed in claim 1 wherein slush or ice crystals are formed in the interior pipe.

8. The crystallizer as claimed in claim 1 wherein the scraper is operated periodically.

9. The crystallizer as claimed in claim 1 wherein the scraper rotates between 0° and 180°.

10. The crystallizer as claimed in claim 1 having salts removal means from the bottom of the chamber.

11. A method for treating produced water comprising the steps of:
a) Feeding produced water to a porous pipe in a chamber wherein the chamber is cylindrically shaped having an interior wall with a top and a bottom;
b) Feeding gaseous nitrogen to a nozzle present in the chamber, wherein the nozzle is in fluid communication with an interior pipe;
c) Feeding the produced water to the interior pipe wherein slush is formed in the pipe and this slush is forced through the interior pipe to the top of the chamber;
d) Operating at least one scraper which is mounted circumferentially about the porous pipe and having arms that extend outwardly from the scraper center in contact with the interior wall of the chamber wherein the scraper will contact and remove salt crystals from the interior walls of the chamber;
e) Recovering salt crystals from the bottom of the chamber; and
f) Recovering fresh water from the chamber.

12. The method as claimed in claim 11 wherein the produced water is from an oil and gas production process.

13. The method as claimed in claim 11 wherein the gaseous nitrogen is formed by feeding liquid nitrogen to a fluid temperature control system.

14. The method as claimed in claim 11 wherein gaseous nitrogen is recovered from the chamber and fed to the fluid temperature control system.

15. The method as claimed in claim 11 wherein the porous pipe distributes the produced water throughout the chamber.

16. The method as claimed in claim 11 wherein the nozzle feeds produced water and gaseous nitrogen to the interior pipe.

17. The method as claimed in claim 11 wherein slush or ice crystals are formed in the interior pipe.

18. The method as claimed in claim 11 wherein the scraper is operated periodically.

19. The method as claimed in claim 11 wherein the scraper rotates between 0° and 180°.

20. The method as claimed in claim 11 wherein salts are removed from the bottom of the chamber.

21. The method as claimed in claim 11 wherein the fresh water is recovered from the chamber through a top pipe.
